(19) United States
(12) Patent Application Publication
(10) Pub. No.: US 2025/0337862 A1
(43) Pub. Date: Oct. 30, 2025

(54) REARVIEW MIRROR ADJUSTMENT SYSTEM, REARVIEW MIRROR ADJUSTMENT METHOD, AND ELECTRONIC REARVIEW MIRROR ASSEMBLY

(71) Applicant: REALTEK SEMICONDUCTOR CORP., Hsinchu (TW)

(72) Inventors: Qing-Zhe Qiu, Suzhou (CN); Dong-Yu He, Suzhou (CN); Hong-Hai Dai, Suzhou (CN); Fang-Ju Zhang, Suzhou (CN)

(73) Assignee: REALTEK SEMICONDUCTOR CORP., Hsinchu (TW)

(21) Appl. No.: 18/972,070

(22) Filed: Dec. 6, 2024

(30) Foreign Application Priority Data
Apr. 30, 2024 (CN) 202410534187.7

(51) Int. Cl. H04N 7/18; B60R 1/26; H04N 23/695; H04N 23/90

(52) U.S. Cl. CPC H04N 7/181; B60R 1/26; H04N 23/695; H04N 23/90; B60R 2300/105; B60R 2300/20

(57) ABSTRACT

A rearview mirror adjustment system, a rearview mirror adjustment method, and an electronic rearview mirror assembly are provided. An image capture module is configured to capture a main image. A first rearview mirror set includes a first camera, a first display screen, and a first driver. The first camera is configured to capture a first image of a first predetermined region. The first display screen is configured to display the first image. The first driver is configured to adjust the first predetermined region when driven. A controller is configured to obtain a line of sight and a moving vector according to the main image. The controller is configured to drive the first driver according to the moving vector in response to the line of sight corresponding to the first display screen and the moving vector not falling in an unmoved region.

### CROSS-REFERENCE TO RELATED APPLICATION

This non-provisional application claims priority under 35 U.S.C. § 119 (a) to Patent Application No. 202410534187.7 filed in China, P.R.C. on Apr. 30, 2024, the entire contents of which are hereby incorporated by reference.

### BACKGROUND

### Technical Field

The present invention relates to a rearview mirror adjustment system, a rearview mirror adjustment method, and an electronic rearview mirror assembly, and in particular, to a rearview mirror adjustment system, a rearview mirror adjustment method, and an electronic rearview mirror assembly that may control an electronic rearview mirror to adjust a viewing angle according to a line of sight of a user in a driving seat and a movement of a body (or a head).

### Related Art

Generally, a driver of a vehicle views a scene around the vehicle through a rearview mirror. Currently, a vehicle has three sets of rearview mirrors, namely, a left rearview mirror, a right rearview mirror, and a central rearview mirror. The left rearview mirror is used for viewing a scene on a left rear of the vehicle. The right rearview mirror is used for viewing a scene on a right rear of the vehicle. The central rearview mirror is used for viewing a scene on a rear of the vehicle. Currently, a rearview mirror is composed of a convex mirror, which expands a field of view of a driver through specular reflection. However, the rearview mirror is limited by factors such as a mirror curvature, a shape, a size, and an angle. Therefore, the rearview mirror has a large blind field of view and is greatly affected by surroundings (such as rain, snow, and a high beam). In addition, the rearview mirror cannot actively provide an expected field of view for a driver, and therefore the driver needs to perform manual angle adjustment.

### SUMMARY

In view of the above, in some embodiments, a rearview mirror adjustment system is provided. The system includes an image capture module and an electronic rearview mirror assembly. The image capture module is configured to capture a main image. The electronic rearview mirror assembly includes a first rearview mirror set and a controller. The first rearview mirror set includes a first camera, a first display screen, and a first driver. The first camera is configured to capture a first image of a first predetermined region. The first display screen is configured to display the first image. The first driver is configured to adjust the first predetermined region when driven. The controller is configured to: obtain a line of sight and a moving vector according to the main image; and drive the first driver according to the moving vector in response to the line of sight corresponding to the first display screen and the moving vector not falling in an unmoved region.

In some embodiments, a rearview mirror adjustment method is provided. The method includes: capturing a main image; obtaining a line of sight and a moving vector according to the main image; and adjusting a first predetermined region according to the moving vector in response to the line of sight corresponding to a first display screen and the moving vector not falling in an unmoved region.

Based on the above, according to the rearview mirror adjustment system and the rearview mirror adjustment method of some embodiments, the image capture module can capture the main image including a user image. The controller obtains the line of sight and the moving vector from the main image, determines the first rearview mirror set, a second rearview mirror set, or a third rearview mirror set the user wants to control according to the line of sight, and then provides the first image, a second image, or a third image corresponding to the moving vector according to the moving vector. According to the rearview mirror adjustment system, the first camera, the second camera, or the third camera corresponding to the line of sight can be turned to a to-be-viewed orientation through the line of sight of the user and a moving direction and a moving amplitude of a body, so that the user can view a scene outside a vehicle.

Various embodiments are described in detail below. However, the embodiments are merely used as examples for description, and do not limit or reduce the protection scope of the present invention. In addition, some elements are omitted in the drawings in the embodiments to clearly show the technical features of the present invention. Same reference numerals in all of the drawings are used to indicate same or similar elements.

### BRIEF DESCRIPTION OF THE DRAWINGS

FIG. 1 is a block diagram of a rearview mirror adjustment system according to some embodiments of the present invention.

FIG. 2 is a top view of a rearview mirror adjustment system arranged on a vehicle according to some embodiments of the present invention.

FIG. 3 is a schematic diagram of a main image captured by an image capture module according to some embodiments of the present invention, showing distribution positions of an unmoved region, a first line-of-sight region, a second line-of-sight region, and a third line-of-sight region in the main image.

FIG. 4 is a partial top view of FIG. 3, showing that a user gazes at a first display screen and moves toward a −X axis.

FIG. 5 is a partial side view of FIG. 3, showing that a user gazes at a first display screen and moves toward a +Z axis.

FIG. 6 is a flowchart of a rearview mirror adjustment method according to some embodiments of the present invention.

### DETAILED DESCRIPTION

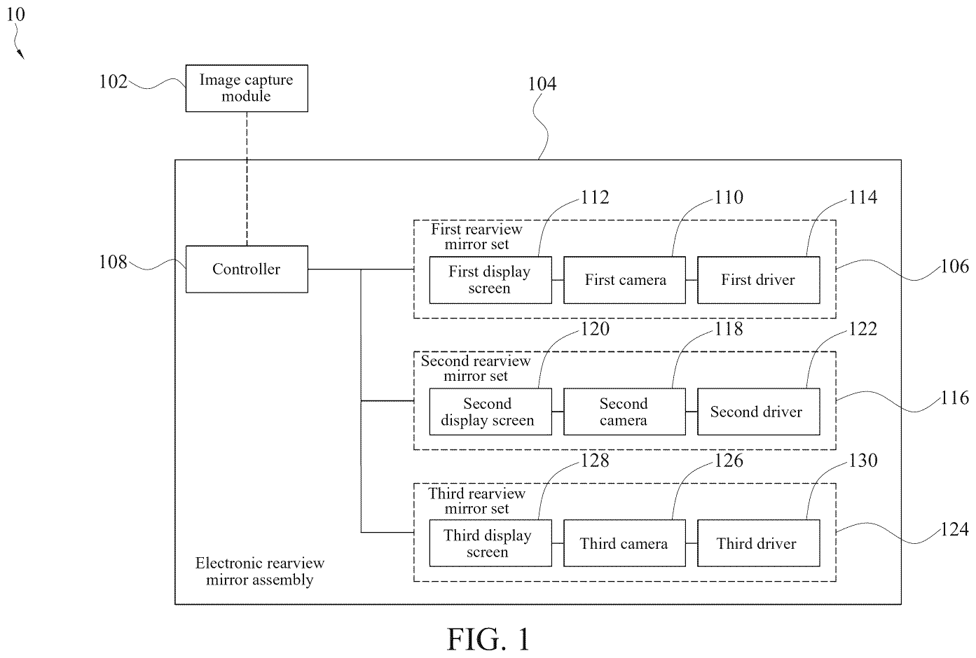

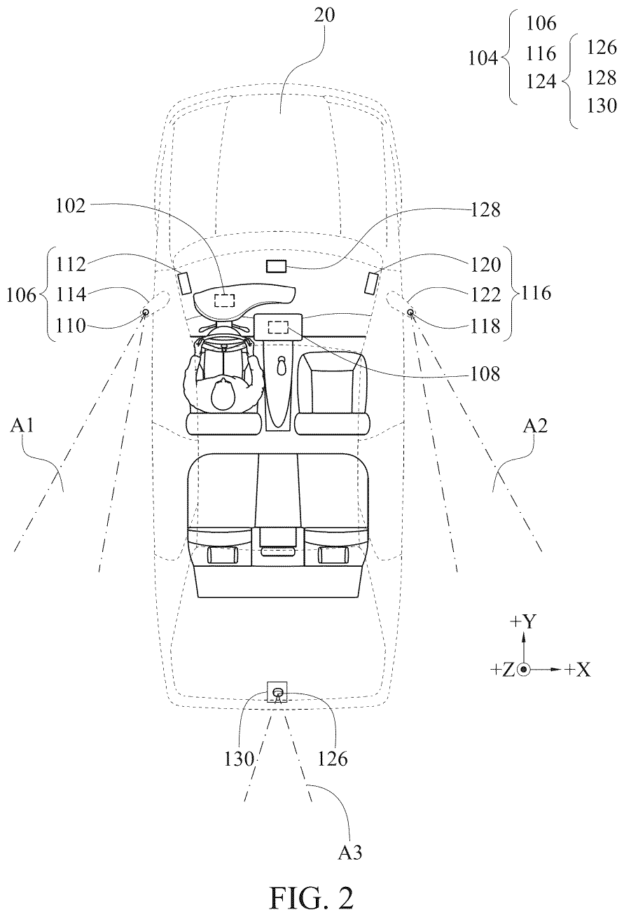

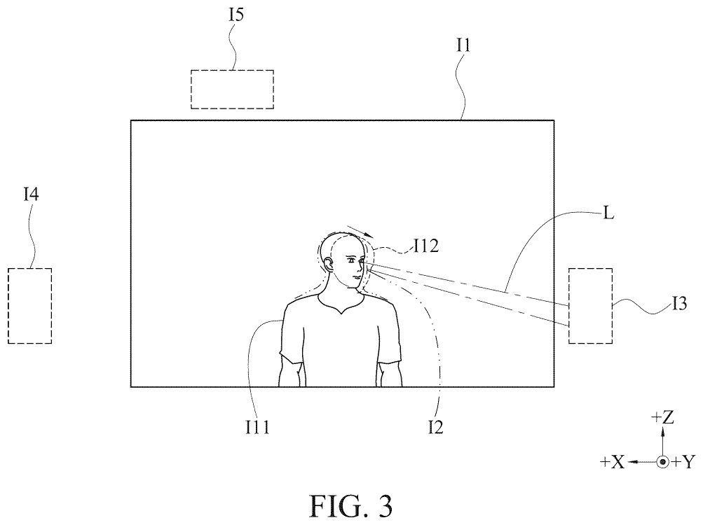

Refer to FIG. 1, FIG. 2, and FIG. 3 together. FIG. 1 is a block diagram of a rearview mirror adjustment system according to some embodiments of the present invention. FIG. 2 is a top view of a rearview mirror adjustment system arranged on a vehicle according to some embodiments of the present invention. FIG. 3 is a schematic diagram of a main image captured by an image capture module according to some embodiments of the present invention, showing distribution positions of an unmoved region, a first line-of-sight region, a second line-of-sight region, and a third line-of-sight region in the main image. As shown in FIG. 1, FIG. 2, and FIG. 3, a rearview mirror adjustment system 10 includes an image capture module 102 and an electronic rearview mirror assembly 104. The image capture module 102 is configured to capture a main image I1. The electronic rearview mirror assembly 104 includes a first rearview mirror set 106 and a controller 108. The first rearview mirror set 106 includes a first camera 110, a first display screen 112, and a first driver 114. The first camera 110 is configured to capture a first image of a first predetermined region A1. The first display screen 112 is configured to display the first image. The first driver 114 is configured to adjust the first predetermined region A1 when driven. The controller 108 is configured to: obtain a line of sight L and a moving vector according to the main image I1, and drive the first driver 114 according to the moving vector in response to the line of sight L corresponding to the first display screen 112 and the moving vector not falling in an unmoved region I2.

The rearview mirror adjustment system 10 may be installed in a vehicle 20, so that a user views a situation outside the vehicle 20 by observing the electronic rearview mirror assembly 104. The rearview mirror adjustment system 10 can automatically adjust the first image displayed on the first rearview mirror set 106 according to a line of sight and a moving action (to be described later) of the user.

The image capture module 102 may be arranged at a position inside the vehicle 20 to face the user (that is, a position facing a driving seat of the vehicle 20), so that the main image I1 captured by the image capture module 102 may include an image of a head or an upper body of the user. The image capture module 102 may be, for example, a fixed camera or a mobile camera. The main image I1 captured by the image capture module 102 may be transmitted to the controller 108 through a transmission line or wireless transmission, so that the controller 108 can analyze the main image I1. In some embodiments, a frame rate of the image capture module 102 is more than 30 frames per second. Therefore, the image capture module 102 can timely transmit the main image I1 to the controller 108 to analyze a behavior of the user, to control the electronic rearview mirror assembly 104 in accordance with the behavior of the user.

The electronic rearview mirror assembly 104 further includes a second rearview mirror set 116 and a third rearview mirror set 124 (to be described later). The first rearview mirror set 106, the second rearview mirror set 116, and the third rearview mirror set 124 may be respectively used as a left rearview mirror, a right rearview mirror, or a central rearview mirror of the vehicle 20. A description is provided below by using the first rearview mirror set 106 as the left rearview mirror, the second rearview mirror set 116 as the right rearview mirror, and the third rearview mirror set 124 as the central rearview mirror, but the present invention is not limited thereto.

The controller 108 may analyze a user image I11 and a line of sight L thereof from the main image I1, and adjust the first rearview mirror set 106, the second rearview mirror set 116, or the third rearview mirror set 124 according to a position of the line of sight L of the user. The controller 108 may be, for example, a central processing unit (CPU), a micro controller (MCU), a graphics processing unit (GPU), an electronic control unit (ECU), a system on a chip (SoC), or any combination thereof.

The controller 108 is the ECU, for example. The ECU may be integrated with the image capture module 102. The main image I1 captured by the image capture module 102 may be instantly transferred to the ECU, so that the ECU reduces a transmission time of the main image I1. In this way, the electronic rearview mirror assembly 104 can react faster to control of the ECU.

The controller 108 is the MCU, for example. The MCU may be implemented by any MCU of an internal system of the vehicle 20. The main image I1 captured by the image capture module 102 may be transmitted to the MCU of the vehicle 20 for analysis, so that the rearview mirror adjustment system 10 can perform analysis with a computing power of the internal system of the vehicle 20.

The controller 108 is the SoC, for example. The SoC may be implemented by integrating the internal system of the vehicle 20 in a single SoC. In this way, the SoC can not only analyze the main image I1 to control the electronic rearview mirror assembly 104, but also control or analyze another electronic device of the vehicle 20.

When the first rearview mirror set 106 is used as the left rearview mirror, the first camera 110 is arranged on a left side of outside of the vehicle 20. A range of the first image captured by the first camera 110 is defined as a first predetermined region A1 (for example, a region on the left side of the outside of the vehicle 20 shown in FIG. 2). It should be noted that, a range of the first predetermined region A1 may vary with a focal length, a field of view (FOV), or an image capture angle of the first camera 110. In other words, the first predetermined region A1 is not a fixed region, and the range thereof is affected by the focal length, the FOV, or the image capture angle of the first camera 110.

The first display screen 112 is arranged at a position on a left side of inside of the vehicle 20. The first display screen 112 displays the first image captured by the first camera 110 when the rearview mirror adjustment system 10 is started (or when the vehicle 20 is started). The user determines a situation on a left side outside the vehicle 20 by viewing the first image displayed on the first display screen 112 (which simulates viewing the left rearview mirror by the user).

When the first driver 114 is driven, the first camera 110 can be driven to rotate, to change the image capture angle of the first camera 110. In some embodiments, the first driver 114 may be a combination of a servo motor, a gear train, and a support frame. The first camera 110 may be fixed to the support frame. After the controller 108 drives the servo motor to rotate, the servo motor drives the support frame through the gear train, to change the image capture angle of the first camera 110.

The foregoing expression “the controller 108 is configured to obtain the line of sight L and the moving vector according to the main image I1” may mean that the controller 108 recognizes the user image I11 of the user from the main image I1 (the user image I11 may include a head image and/or an eye image), and determines the line of sight L of the user according to the user image I11. The controller 108 may execute an image recognition program to recognize the user image I11 from the main image I1 and obtain the line of sight L. For example, during the execution of the image recognition program, the controller 108 may determine a plurality of key point coordinates (which may include, for example, an eye coordinate, a nose coordinate, and a mouth coordinate) in a preset face recognition model, and determine the line of sight L according to relative positions of the plurality of key point coordinates and the image capture module 102. For another example, the image capture module 102 has an infrared module (not shown in the figure). The infrared module emits an infrared ray. When the user is in the driving seat, the infrared ray may be irradiated to eyeballs of the user. The controller 108 may determine a position of the line of sight L in the main image I1 according to the infrared ray reflected from the eyeballs. After the controller 108 obtains the user image I11 from the main image I1, relative positions of a user moving image I12 and the unmoved region I2 may be compared to obtain the moving vector.

In some embodiments, the unmoved region I2 may refer to a region of the head image or the eye image (namely, the unmoved region I2) obtained by the controller 108 from the main image I1 when the user drives while looking straight at a front of the vehicle 20 (or looking at the image capture module 102). For example, the unmoved region I2 may be a region, in the main image I1, of the head image or the eye image captured by the image capture module 102 within a predetermined time (for example, three seconds) when the user starts a power supply of the vehicle 20 (or of the rearview mirror adjustment system 10) and looks at the front of the vehicle 20. The unmoved region I2 may also be a region of the main image I1 obtained by the controller 108 from the user image I11 when receiving an initial setting signal (alternatively, the unmoved region I2 may be formed around the user image I11). The initial setting signal may be an initial setting signal transmitted by a central control host of the vehicle 20 when the user starts the power supply of the vehicle 20 in the driving seat. The initial setting signal may also be an initial setting signal transmitted through the central control host when the user manually operates the central control host in the driving seat. The initial setting signal may also be an initial setting signal generated by the image capture module 102 when the user manually starts the image capture module 102 in the driving seat. The initial setting signal and the main image I1 are transmitted to the controller 108 (the image capture module 102 may also first transmit the initial setting signal and then capture the main image I1), so that the controller 108 recognizes the user image I11 from the main image I1 according to the initial setting signal. A region of the user image I11 in the main image I1 is used as the unmoved region I2 (alternatively, a region around the user image I11 may be used as the unmoved region I2).

The foregoing expression “the controller 108 is configured to drive the first driver 114 according to the moving vector in response to the line of sight L corresponding to the first display screen 112 and the moving vector not falling in an unmoved region I2” may mean that the controller 108 adjusts the first image of the first predetermined region A1 according to a moving amplitude and a moving direction of the body of the user when the line of sight L falls on the first display screen 112. Specifically, the controller 108 may transmit a first control signal to the first driver 114 according to the moving vector when the line of sight L is located in a first line-of-sight region I3 of the main image I1, so that the first driver 114 can rotate according to the first control signal. The first line-of-sight region I3 may be a region in the main image I1 corresponding to the position at which the first display screen 112 is arranged on the vehicle 20. For example, if the first display screen 112 is arranged on the left side of the vehicle 20, the first line-of-sight region I3 is located in a left side region of the main image I1. In some embodiments, the controller 108 converts the moving vector obtained according to the main image I1 to a moving amplitude and a moving direction corresponding to the first image, and transmits the first control signal having the moving amplitude and the moving direction to the first driver 114. The first driver 114 performs corresponding rotation based on the moving amplitude and the moving direction of the first control signal.

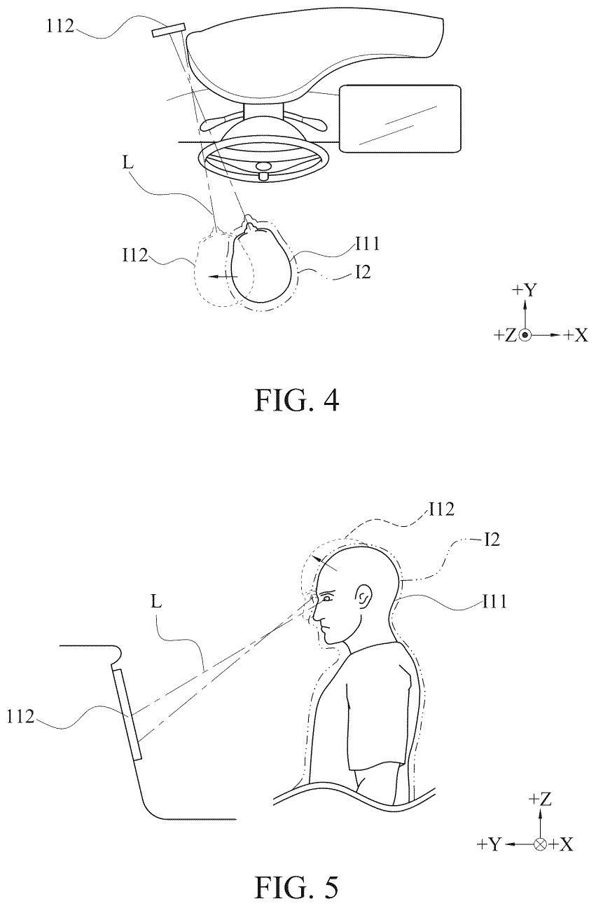

Refer to FIG. 1, FIG. 2, FIG. 3, and FIG. 4 together. FIG. 4 is a partial top view of FIG. 3, showing that a user gazes at a first display screen and moves toward a −X axis. As shown in FIG. 1, FIG. 2, FIG. 3, and FIG. 4, in some embodiments, the controller 108 may control the electronic rearview mirror assembly 104 according to a habit of the user when viewing a rearview mirror. The foregoing expression “drive the first driver 114 according to the moving vector” further includes: driving the first driver 114, so that the first predetermined region A1 is adjusted in a direction opposite to the moving vector at an adjustment amplitude in a proportional relationship with a magnitude of the moving vector. For example, as shown in FIG. 4, when the user facing the image capture module 102 moves leftward (as shown in FIG. 4, the user image I11 moves toward the −X axis to form the user moving image I12), it indicates that the user wants to view a scene close to a vehicle body. In this case, the moving vector is moving toward the −X axis in FIG. 4. The controller 108 drives the first driver 114 to move toward a +X axis in FIG. 2, so that the first predetermined region A1 captured by the first camera 110 approaches the vehicle body. Conversely, when the user facing the image capture module 102 moves rightward (as shown in FIG. 4, the user image I11 moves toward the +X axis to form the user moving image I12), it indicates that the user wants to view a scene away from the vehicle body. In this case, the moving vector is moving toward the +X axis in FIG. 4. The controller 108 drives the first driver 114 to move toward the +X axis in FIG. 2, so that the first predetermined region A1 captured by the first camera 110 moves away from the vehicle body.

Refer to FIG. 1, FIG. 2, FIG. 3, and FIG. 5 together. FIG. 5 is a partial side view of FIG. 3, showing that a user gazes at a first display screen and moves toward a +Z axis. As shown in FIG. 1, FIG. 2, FIG. 3, and FIG. 5, when the user facing the image capture module 102 moves upward (as shown in FIG. 5, the user image I11 moves toward the +Z axis to form the user moving image I12), it indicates that the user wants to view a scene close to a bottom of the vehicle. In this case, the moving vector is moving toward the +Z axis in FIG. 5. The controller 108 drives the first driver 114 to move toward the −X axis in FIG. 2, so that the first predetermined region A1 captured by the first camera 110 approaches the bottom of the vehicle. Conversely, when the user facing the image capture module 102 moves downward (as shown in FIG. 5, the user image I11 moves toward a −Z axis to form the user moving image I12), it indicates that the user wants to view a scene close to a roof of the vehicle. In this case, the moving vector is moving toward the −Z axis in FIG. 5. The controller 108 drives the first driver 114 to move toward the +Y axis in FIG. 2, so that the first predetermined region A1 captured by the first camera 110 approaches the roof of the vehicle.

Still as shown in FIG. 4, in the foregoing embodiment of adjusting the first driver 114, the proportional relationship of the first driver 114 between the adjustment amplitude and the moving vector is 1:1. If the proportional relationship between the first driver 114 and the moving vector is 2:1, and the moving vector is moving by 15 degrees toward the +X axis (for example, the +X axis shown in FIG. 4), the first driver 114 merely needs to move by 7.5 degrees toward the −X axis (for example, the −X axis shown in FIG. 4) to adjust the first predetermined region A1 to a position to be viewed by the user.

Still as shown in FIG. 1, FIG. 2, and FIG. 3, in some embodiments, the foregoing second rearview mirror set 116 includes a second camera 118, a second display screen 120, and a second driver 122. The second camera 118 is configured to capture a second image of a second predetermined region A2. The second display screen 120 is configured to display the second image. The second driver 122 is configured to adjust the second predetermined region A2 when driven. The controller 108 is further configured to drive the second driver 122 according to the moving vector in response to the line of sight L corresponding to the second display screen 120 and the moving vector not falling in the unmoved region I2.

Still as shown in FIG. 2, the second rearview mirror set 116 operates similarly to the first rearview mirror set 106, but is arranged at a different position on the vehicle 20. For example, when the second rearview mirror set 116 is used as the right rearview mirror, the second camera 118 is arranged on a right side of the outside of the vehicle 20. A range of the second image captured by the second camera 118 is defined as the second predetermined region A2 (for example, a region on the right side of the outside of the vehicle 20 shown in FIG. 2).

Still as shown in FIG. 2, the second display screen 120 is arranged at a position on a right side of the inside of the vehicle 20. The second display screen 120 displays the second image captured by the second camera 118 when the rearview mirror adjustment system 10 is started (or when the vehicle 20 is started). The user determines a situation on a right side outside the vehicle 20 by viewing the second image displayed on the second display screen 120 (which simulates viewing the second rearview mirror by the user).

When the second driver 122 is driven, the second camera 118 can be driven to rotate, to change an image capture angle of the second camera 118.

Still as shown in FIG. 1, FIG. 2, and FIG. 3, the foregoing expression “drive the second driver 122 according to the moving vector in response to the line of sight L corresponding to the second display screen 120 and the moving vector not falling in the unmoved region I2” may mean that the controller 108 adjusts the second image of the second predetermined region A2 according to a moving amplitude and a moving direction of the body of the user when the line of sight L falls on the second display screen 120. Specifically, the controller 108 may transmit a second control signal to the second driver 122 according to the moving vector when the line of sight L is located in a second line-of-sight region I4 of the main image I1, so that the second driver 122 can rotate according to the second control signal. The second line-of-sight region I4 may be a region in the main image I1 corresponding to the position at which the second display screen 120 is arranged on the vehicle 20. For example, if the second display screen 120 is arranged on the right side of the vehicle 20, the second line-of-sight region I4 is located in a right side region of the main image I1. In some embodiments, the controller 108 converts the moving vector obtained according to the main image I1 to a moving amplitude and a moving direction corresponding to the second image, and transmits the second control signal having the moving amplitude and the moving direction to the second driver 122. The second driver 122 performs corresponding rotation based on the moving amplitude and the moving direction of the second control signal.

In some embodiments, the above expression “drive the second driver 122 according to the moving vector” further includes: driving the second driver 122, so that the second predetermined region A2 is adjusted in a direction opposite to the moving vector at an adjustment amplitude in a proportional relationship with a magnitude of the moving vector. The second driver 122 operates according to the moving vector similarly to the first driver 114, and reference may be made to the above description of the first driver 114. It should be noted that, the proportional relationship of the second driver 122 between the adjustment amplitude and the moving vector may be the same as or different from that of the first driver 114. For example, an angle or a distance at which the user views the first display screen 112 in the driving seat may not be the same as an angle or a distance at which the user views the second display screen 120. Therefore, the proportional relationship of the first driver 114 between the adjustment amplitude and the moving vector is different from that of the second driver 122.

Still as shown in FIG. 2, in some embodiments, the first display screen 112 and the second display screen 120 are located on two opposite sides of the image capture module 102. Specifically, to cater to the habits of the user when viewing the left rearview mirror and the right rearview mirror, the first display screen 112 and the second display screen 120 may be arranged on the two opposite sides of the image capture module 102, and the first display screen 112 and the second display screen 120 may be arranged at a same height inside the vehicle 20.

In some embodiments, the foregoing third rearview mirror set 124 includes a third camera 126, a third display screen 128, and a third driver 130. The third camera 126 is configured to capture a third image of a third predetermined region A3. The third display screen 128 is configured to display the third image. The third driver 130, is configured to adjust the third predetermined region A3 when driven. The controller 108 is configured to drive the third driver 130 according to the moving vector in response to the line of sight L corresponding to the third display screen 128 and the moving vector not falling in the unmoved region I2.

The third rearview mirror set 124 operates similarly to the first rearview mirror set 106 and the second rearview mirror set 116, but is arranged at a different position on the vehicle 20. For example, when the third rearview mirror set 124 is used as the central rearview mirror, the third camera 126 is arranged on a rear of the vehicle 20. A range of the third image captured by the third camera 126 is defined as the third predetermined region A3 (a region behind the vehicle 20 shown in FIG. 2).

Still as shown in FIG. 2, the third display screen 128 is arranged inside the vehicle 20 and is located between the first display screen 112 and the second display screen 120. The third display screen 128 displays the third image captured by the third camera 126 when the rearview mirror adjustment system 10 is started (or when the vehicle 20 is started). The user determines a situation behind the vehicle 20 by viewing the third image displayed on the third display screen 128 (which simulates viewing the central rearview mirror by the user).

When the third driver 130 is driven, the third camera 126 can be driven to rotate, to change an image capture angle of the third camera 126.

Still as shown in FIG. 1, FIG. 2, and FIG. 3, the foregoing expression “drive the third driver 130 according to the moving vector in response to the line of sight L corresponding to the third display screen 128 and the moving vector not falling in the unmoved region I2” may mean that the controller 108 adjusts the third image of the third predetermined region A3 according to a moving amplitude and a moving direction of the body of the user when the line of sight L falls on the third display screen 128. Specifically, the controller 108 may transmit a third control signal to the third driver 130 according to the moving vector when the line of sight L is located in a third line-of-sight region I5 of the main image I1, so that the third driver 130 can rotate according to the third control signal. The third line-of-sight region I5 may be a region in the main image I1 corresponding to the position at which the third display screen 128 is arranged on the vehicle 20. For example, if the third display screen 128 is arranged inside the vehicle 20 and is located between the first display screen 112 and the second display screen 120, the third line-of-sight region I5 is located between the first line-of-sight region I3 and the second line-of-sight region I4 of the main image I1. In some embodiments, the controller 108 converts the moving vector obtained according to the main image I1 to a moving amplitude and a moving direction corresponding to the third image, and transmits the third control signal having the moving amplitude and the moving direction to the third driver 130. The third driver 130 performs corresponding rotation based on the moving amplitude and the moving direction of the third control signal.

Still as shown in FIG. 1, FIG. 2, and FIG. 3, in some embodiments, the above expression “drive the third driver 130 according to the moving vector” further includes: driving the third driver 130, so that the third predetermined region A3 is adjusted in a direction opposite to the moving vector at an adjustment amplitude in a proportional relationship with a magnitude of the moving vector. The third driver 130 operates according to the moving vector similarly to the first driver 114 and the second driver 122, and reference may be made to above descriptions of the first driver 114 and the second driver 122. It should be noted that, the proportional relationship of the third driver 130 between the adjustment amplitude and the moving vector may be the same as or different from that of the first driver 114 or the second driver 122. For example, an angle or a distance at which the user views the first display screen 112 in the driving seat may not be the same as an angle or a distance at which the user views the second display screen 120. Therefore, the proportional relationship of the first driver 114 between the adjustment amplitude and the moving vector is different from that of the second driver 122.

In some embodiments, when the line of sight L returns to the unmoved region I2 from the first line-of-sight region I3, the second line-of-sight region I4, or the third line-of-sight region I5, it indicates that the user no longer needs to view the rearview mirror. The controller 108 may drive the first driver 114, the second driver 122, and/or the third driver 130 to return to a preset position. The preset position may be a position at which the first driver 114, the second driver 122, or the third driver 130 is an initial state. The preset position may also be a position of the first driver 114, the second driver 122, or the third driver 130 recorded by the controller 108 after the user manually adjusts the position of the first driver 114, the second driver 122, or the third driver 130.

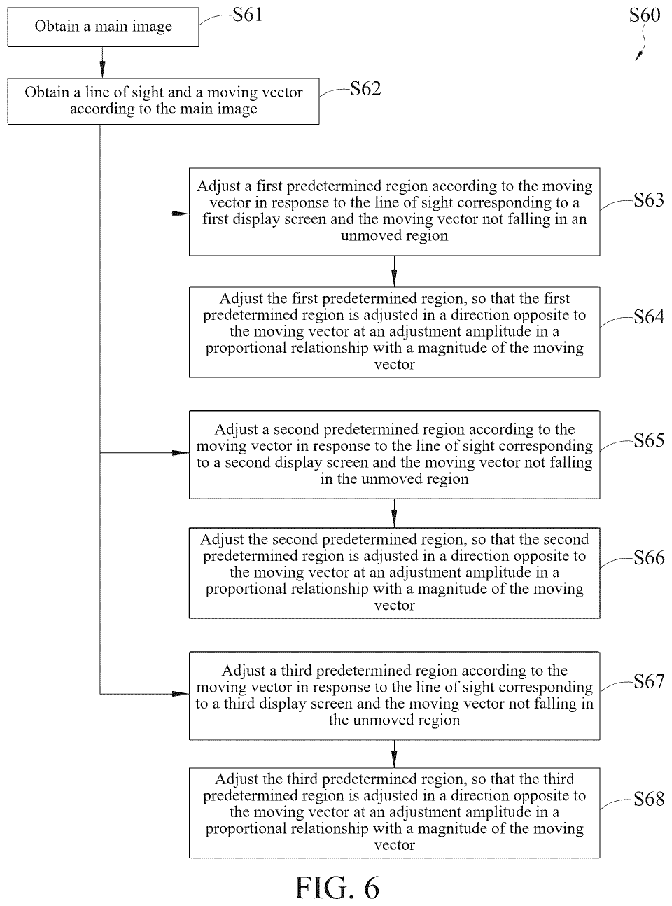

Referring to FIG. 6, FIG. 6 is a flowchart of a rearview mirror adjustment method according to some embodiments of the present invention. A rearview mirror adjustment method S60 includes the following steps.
Step S61: Capture a main image I1.
Step S62: Obtain a line of sight L and a moving vector according to the main image I1.
Step S63: Adjust a first predetermined region A1 according to the moving vector in response to the line of sight L corresponding to a first display screen 112 and the moving vector not falling in an unmoved region I2.

In some embodiments, step S63 further includes step S64. Step S64: Adjust the first predetermined region A1, so that the first predetermined region A1 is adjusted in a direction opposite to the moving vector at an adjustment amplitude in a proportional relationship with a magnitude of the moving vector.

In some embodiments, the rearview mirror adjustment method S60 further includes step S65. Step S65: Adjust a second predetermined region A2 according to the moving vector in response to the line of sight L corresponding to a second display screen 120 and the moving vector not falling in the unmoved region I2.

In some embodiments, step S65 further includes step S66. Step S66: Adjust the second predetermined region A2, so that the second predetermined region A2 is adjusted in a direction opposite to the moving vector at an adjustment amplitude in a proportional relationship with a magnitude of the moving vector.

In some embodiments, the rearview mirror adjustment method S60 further includes step S67. Step S67: Adjust a third predetermined region A3 according to the moving vector in response to the line of sight L corresponding to a third display screen 128 and the moving vector not falling in the unmoved region I2.

In some embodiments, step S67 further includes step S68. Step S68: Adjust the third predetermined region A3, so that the third predetermined region A3 is adjusted in a direction opposite to the moving vector at an adjustment amplitude in a proportional relationship with a magnitude of the moving vector.

It should be noted that, a controller 108 may selectively perform step S63, step S65, and step S67. Specifically, according to a habit of a user when viewing a rearview mirror, the user can view only the first display screen 112, the second display screen 120, or the third display screen 128 at the same moment. The controller 108 may use the line of sight L as a condition for triggering step S63, step S65, or step S67. For example, the controller 108 performs step S63 when the line of sight L is located in a first line-of-sight region I3, performs step S65 when the line of sight L is located in a second line-of-sight region I4, and performs step S67 when the line of sight L is located in a third line-of-sight region I5.

Based on the above, according to the rearview mirror adjustment system 10 and the rearview mirror adjustment method S60 of some embodiments, the image capture module 102 can capture the main image I1 including the user image I11. The controller 108 obtains the line of sight L and the moving vector from the main image I1, determines the first rearview mirror set 106, the second rearview mirror set 116, or the third rearview mirror set 124 the user wants to control according to the line of sight L, and then provides the first image, the second image, or the third image corresponding to the moving vector according to the moving vector. According to the rearview mirror adjustment system 10, the first camera 110, the second camera 118, or the third camera 126 corresponding to the line of sight L can be turned to a to-be-viewed orientation through the line of sight L of the user and the moving direction and the moving amplitude of the body, so that the user can view the scene outside the vehicle 20.

The foregoing embodiments are merely used for describing the technical ideas and characteristics of the present disclosure, to enable a person skilled in the art to understand and hereby implement the content of the present disclosure. However, the scope of the claims of the present disclosure is not limited thereto. In other words, any equivalent changes or modifications made according to the spirit disclosed in the present disclosure shall still fall into scope of the claims of the present disclosure.

What is claimed is:

1. A rearview mirror adjustment system, comprising:
an image capture module, configured to capture a main image; and
an electronic rearview mirror assembly, comprising:
a first rearview mirror set, comprising:
a first camera, configured to capture a first image of a first predetermined region;
a first display screen, configured to display the first image; and
a first driver, configured to adjust the first predetermined region when driven; and
a controller, configured to:
obtain a line of sight and a moving vector according to the main image; and
drive the first driver according to the moving vector in response to the line of sight corresponding to the first display screen and the moving vector not falling in an unmoved region.

2. The rearview mirror adjustment system according to claim 1, wherein the driving the first driver according to the moving vector comprises: driving the first driver, so that the first predetermined region is adjusted in a direction opposite to the moving vector at an adjustment amplitude in a proportional relationship with a magnitude of the moving vector.

3. The rearview mirror adjustment system according to claim 1, wherein the electronic rearview mirror assembly further comprises:
a second rearview mirror set, comprising:
a second camera, configured to capture a second image of a second predetermined region;
a second display screen, configured to display the second image; and
a second driver, configured to adjust the second predetermined region when driven, wherein
the controller is configured to drive the second driver according to the moving vector in response to the line of sight corresponding to the second display screen and the moving vector not falling in the unmoved region.

4. The rearview mirror adjustment system according to claim 3, wherein the driving the second driver according to the moving vector comprises: driving the second driver, so that the second predetermined region is adjusted in a direction opposite to the moving vector at an adjustment amplitude in a proportional relationship with a magnitude of the moving vector.

5. The rearview mirror adjustment system according to claim 3, wherein the first display screen and the second display screen are located on two opposite sides of the image capture module.

6. The rearview mirror adjustment system according to claim 3, wherein the electronic rearview mirror assembly further comprises:
a third rearview mirror set, comprising:
a third camera, configured to capture a third image of a third predetermined region;
a third display screen, configured to display the third image; and
a third driver, configured to adjust the third predetermined region when driven, wherein
the controller is configured to drive the third driver according to the moving vector in response to the line of sight corresponding to the third display screen and the moving vector not falling in the unmoved region.

7. The rearview mirror adjustment system according to claim 6, wherein the driving the third driver according to the moving vector comprises: driving the third driver, so that the third predetermined region is adjusted in a direction opposite to the moving vector at an adjustment amplitude in a proportional relationship with a magnitude of the moving vector.

8. The rearview mirror adjustment system according to claim 6, wherein the third display screen is located between the first display screen and the second display screen.

9. A rearview mirror adjustment method, comprising:
capturing a main image;
obtaining a line of sight and a moving vector according to the main image; and
adjusting a first predetermined region according to the moving vector in response to the line of sight corresponding to a first display screen and the moving vector not falling in an unmoved region.

10. The rearview mirror adjustment method according to claim 9, wherein the step of adjusting the first predetermined region according to the moving vector comprises: adjusting the first predetermined region, so that the first predetermined region is adjusted in a direction opposite to the moving vector at an adjustment amplitude in a proportional relationship with a magnitude of the moving vector.

11. The rearview mirror adjustment method according to claim 9, further comprising:
adjusting a second predetermined region according to the moving vector in response to the line of sight corresponding to a second display screen and the moving vector not falling in the unmoved region.

12. The rearview mirror adjustment method according to claim 11, wherein the step of adjusting the second predetermined region according to the moving vector comprises: adjusting the second predetermined region, so that the second predetermined region is adjusted in a direction opposite to the moving vector at an adjustment amplitude in a proportional relationship with a magnitude of the moving vector.

13. The rearview mirror adjustment method according to claim 11, further comprising:
adjusting a third predetermined region according to the moving vector in response to the line of sight corresponding to a third image and the moving vector not falling in the unmoved region.

14. The rearview mirror adjustment method according to claim 13, wherein the step of adjusting the third predetermined region according to the moving vector comprises: adjusting the third predetermined region, so that the third predetermined region is adjusted in a direction opposite to the moving vector at an adjustment amplitude in a proportional relationship with a magnitude of the moving vector.

15. An electronic rearview mirror assembly, comprising:
a first rearview mirror set, comprising:
a first camera, configured to capture a first image of a first predetermined region;
a first display screen, configured to display the first image; and
a first driver, configured to adjust the first predetermined region when driven; and
a controller, configured to:
obtain a line of sight and a moving vector according to a main image; and
drive the first driver according to the moving vector in response to the line of sight corresponding to the first display screen and the moving vector not falling in an unmoved region.

16. The electronic rearview mirror assembly according to claim 15, wherein the driving the first driver according to the moving vector comprises: driving the first driver, so that the first predetermined region is adjusted in a direction opposite to the moving vector at an adjustment amplitude in a proportional relationship with a magnitude of the moving vector.

17. The electronic rearview mirror assembly according to claim 15, wherein the electronic rearview mirror assembly further comprises:
a second rearview mirror set, comprising:
a second camera, configured to capture a second image of a second predetermined region;
a second display screen, configured to display the second image; and
a second driver, configured to adjust the second predetermined region when driven, wherein
the controller is configured to drive the second driver according to the moving vector in response to the line of sight corresponding to the second display screen and the moving vector not falling in the unmoved region.

18. The electronic rearview mirror assembly according to claim 17, wherein the step of driving the second driver according to the moving vector comprises: driving the second driver, so that the second predetermined region is adjusted in a direction opposite to the moving vector at an adjustment amplitude in a proportional relationship with a magnitude of the moving vector.

19. The electronic rearview mirror assembly according to claim 17, wherein the electronic rearview mirror assembly further comprises:
a third rearview mirror set, comprising:
a third camera, configured to capture a third image of a third predetermined region;
a third display screen, configured to display the third image; and
a third driver, configured to adjust the third predetermined region when driven, wherein
the controller is configured to drive the third driver according to the moving vector in response to the line of sight corresponding to the third display screen and the moving vector not falling in the unmoved region.

20. The electronic rearview mirror assembly according to claim 19, wherein the step of driving the third driver according to the moving vector comprises: driving the third driver, so that the third predetermined region is adjusted in a direction opposite to the moving vector at an adjustment amplitude in a proportional relationship with a magnitude of the moving vector.
